(19) United States
(12) Patent Application Publication
(10) Pub. No.: US 2016/0092420 A1
(43) Pub. Date: Mar. 31, 2016

(54) Computer-Implemented Methods, Computer Readable Media, And Systems For Co-Editing Content

(71) Applicant: OSIX Corporation, Redwood City, CA (US)

(72) Inventors: ADRIAN CESENA, Palo Alto, CA (US); Amir Ghazvinian, San Francisco, CA (US)

(21) Appl. No.: 14/862,959

(22) Filed: Sep. 23, 2015

Related U.S. Application Data
(60) Provisional application No. 62/055,523, filed on Sep. 25, 2014.
(60) Provisional application No. 62/063,677, filed on Oct. 14, 2014.

(51) Int. Cl. G06F 17/24; H04L 29/08; G06F 17/22; G06F 17/21; G06F 3/0484; G06F 3/0481

(52) U.S. Cl. CPC G06F 17/24; G06F 3/0484; G06F 3/04812; G06F 17/2247; G06F 17/211; H04L 67/10; H04L 67/02

(57) ABSTRACT

A host system hosts a co-editing session in which edits to a document are received from multiple computer systems. The host system edits the document according to the received edits, renders the edited document in a virtual screen, and transmits images of the virtual screen to the multiple computer systems. The images of the virtual screen are translated according to the type of the computer system to which it is transmitted. The document may be a webpage, such as an online form. The edits may be edits to the webpage, such as entries in an online form.

### RELATED APPLICATIONS

This application claims the benefit of U.S. Provisional Application Ser. No. 62/055,523 filed Sep. 25, 2014, and entitled “Computer-Implemented Methods, Computer Readable Media, And Systems for Co-Editing Content,” which is hereby incorporated herein by reference in its entirety.

This application claims the benefit of U.S. Provisional Application Ser. No. 62/063,677 filed Oct. 14, 2014, and entitled “Computer-Implemented Methods, Computer Readable Media, And Systems for Co-Editing Content,” which is hereby incorporated herein by reference in its entirety.

### FIELD OF THE INVENTION

The present invention is related to the field of computing, and more specifically to techniques for initiating the use of applications over a network.

### BACKGROUND

The Internet has become an essential medium for business and media. Although use of the Internet in modern society is essentially ubiquitous, one potential area of future expansion in the Internet is the ability for users to share online experiences. Sharing online experiences, such as visiting websites, is one way for users to have a social experience on the Internet. These shared online experiences often take the form of co-browsing. In general, co-browsing is joint navigation of websites by multiple people that access web pages at the same time. Some current techniques for co-browsing require special software at the client and/or co-browsing enabled websites. Since users may only co-browse on web sites that are co-browsing enabled, this technology limits the users to only a small subset of Internet sites. As a consequence, it is desirable to create a co-browsing system that does not require special plug-ins or co-browsing enabled websites so as to permit users to co-browse at any website.

### SUMMARY OF THE INVENTION

The present invention is related to the field of computing, and more specifically to techniques for co-editing content over a network.

The Internet has become an essential medium for business and media. Although use of the Internet in modern society is essentially ubiquitous, one potential area of future expansion in the Internet is the ability for users to share online experiences. Sharing online experiences, such as visiting websites, is one way for users to have a social experience on the Internet. These shared online experiences often take the form of co-browsing. In general, co-browsing is the joint navigation of websites by multiple people who access web pages at the same time. Some current techniques for co-browsing require special software at the client and/or co-browsing enabled websites. Since users may only co-browse on web sites that are co-browsing enabled, this technology limits the users to only a small subset of Internet sites. As a consequence, it is desirable to create a co-browsing system that does not require special plug-ins or co-browsing enabled websites so as to permit users to co-browse at any website.

Co-browsing is an embodiment of the co-use of an application via a network. Co-editing is another embodiment of the co-use of an application via a network. In co-editing according to embodiments, a computer-implemented method, computer readable medium and system allow one or more computer devices to co-edit a file, such as a pdf or text file. That is, the devices may participate in the simultaneous use of the same application, or “co-use” the application to edit content. Some current approaches to editing documents on-line, such as Google Docs®, allow multiple users to each edit their copy of a document in parallel. Subsequently, the collective edits are sent to a server that incorporates them into a single document and distributes that document. Such parallel editing may result in redundant edits that waste collective energy and may produce conflicting edits, which would require additional work to harmonize. In traditional screen sharing applications, such as Joinme®, the document resides on one host user's computer and a participating user may send instructions to the host user's computer. In such applications, the guest user may actually acquire control of the host user's computer. These current approaches do not provide the interactive experience that co-editing does according to current embodiments. In co-editing embodiments, co-users may edit content simultaneously, as if each co-user were present in a single location, and without the possibility of surrendering control of their computer to another.

Co-editing of content via a network in general may involve a number of different user devices, in addition to servers and other network components. The devices, servers, and network components may have substantially different capabilities and input devices. In embodiments, the input from disparate input devices may be translated and incorporated into co-edited content, and then displayed, via a virtual display, to co-editing users on different devices.

A computer-implemented method, computer readable medium and system provide for co-editing. In embodiments, one or more computer devices are connected to a network. A virtual application and virtual display are instantiated that allow the viewing and co-editing of content by accepting edits from connected user computer devices, incorporating the edits into the content, and then displaying the edited content to the user computer devices.

In an embodiment, a manager (or “dispatcher”) is an element of a virtual application that allows users to co-edit content via a network. A host initiates a co-editing session over a network with a request. The manager receives the request and initiates batch processes to instantiate a virtual screen, a virtual application with editing capabilities, and a user interface (UI) server on at least one server. That is, the manager initiates the instantiation of an application program on the at least one server so as to run a “virtual application” on the server. The virtual application may be used in a co-editing session by multiple users. The multiple users may employ various computer devices with differing capabilities and input devices. The manager may determine the capabilities of the various computer devices. The manager may translate input from disparate devices and optimize output from the virtual display for the disparate devices. In an embodiment, input from each connected computer device is translated individually. In an embodiment, output for each connected computer device is optimized individually. A described within, embodiments using a browser to access a particular file are exemplary and the methods should be understood to apply to computer applications generally.

In one aspect of the invention a method includes: (a) associating, by a host system, a first computer system and a second computer system with a co-editing session with respect to a document; (b) rendering, by the host system, the document in a virtual screen using a virtual client; (c) receiving, by the host system, edits to the document from the first and second computer systems; (d) editing, by the host system, the document according to the edits; (e) translating, by the host system, images of the virtual screen to obtain first images suitable for presentation on the first computer system; (f) translating, by the host system, images of the virtual screen to obtain second images suitable for presentation on the second computer system, the second images being translated differently than the first images; (g) transmitting, by the host system, the first images of the virtual screen to the first computer system in response to the edits to the document; and (h) transmitting, by the host system, the second images of the virtual screen to the second computer system in response to the edits to the document.

In some embodiments, the document is a webpage and the virtual client is a virtual web browser. The webpage may be an online form and the edits may be inputs to blanks of the online form.

In some embodiments, the method further includes (a) receiving, by the host system from the first computer system, instructions for filling of the online form; (b) transmitting, by the host system to the second computer system, the instructions for filling the online form; and (c) receiving, by the host system, the inputs to the blanks of the online form from the second computer system.

In some embodiments, the first images are formatted for a different screen size then the second images. In some embodiments, the first images are formatted for display on a mobile computing device and the second images are formatted for display on a high-resolution desktop computer.

In some embodiments, the method further includes (a) instantiating a user interface server on the host system; (b) receiving, by the user interface server, the edits; and (c) inputting, by the user interface server, the edits to the virtual client.

In some embodiments, the method includes establishing a network connection between the virtual client and a proxy and establishing network connections between the proxy and the first and second computer systems.

In some embodiments, the edits include at least one of keystrokes, cursor movements, and clicks.

A system for performing the above-described method is also disclosed and claimed herein.

### BRIEF DESCRIPTION OF THE FIGURES

For purpose of explanation, several embodiments of the invention are set forth in the following figures.

FIG. 1 is a block diagram illustrating a number of embodiments for implementing the co-editing of content over a network.

FIG. 2 is a flow diagram illustrating an embodiment for implementing the co-editing of content over a network.

FIG. 3 is a flow diagram illustrating an embodiment for implementing the co-editing of content over a network.

FIG. 4 is a block diagram illustrating a system to permit computers to remotely share computing resources.

FIG. 5 is a block diagram illustrating one embodiment of a computer architecture to support remote operation of applications for use by one or more computing devices.

FIG. 6 is a flow diagram illustrating one embodiment to initiate a session among multiple users to co-use an application program.

FIG. 7 is a flow diagram illustrating one embodiment for a process for multiple users to co-use an application program.

FIG. 8 is a block diagram illustrating one embodiment for implementing distributed computing and Internet co-browsing among multiple users.

FIG. 9 is a flow diagram illustrating one embodiment for a distributed computing and a co-browsing session.

FIG. 10 is a flow diagram illustrating one embodiment for a distributed computing and a co-browsing process.

FIG. 11 is a block diagram illustrating a system configured to implement distributed computing and the co-use of an application.

FIG. 12 is a flow diagram illustrating one embodiment for implementing a distributed computing and co-browsing session.

FIG. 13 is a block diagram illustrating co-browsing with multiple co-browser instantiations at the virtual server.

FIG. 14 is a diagrammatic representation of a network and a computer system.

### BRIEF DESCRIPTION OF THE FIGURES

Embodiments of co-editing over a network allow users to edit content interactively. Such content may include documents, forms, code, images, and video. Essentially, anything editable by a single user using an application on a single computer may be transmitted to a virtual version of the application running on a virtual server on a network and edited by co-users of the virtual application. For example, a pdf file may be opened in a virtual browser, or a virtual pdf-specific application, and co-edited. The editable content itself may be pulled into the virtual application for co-editing from any location accessible by the virtual application, e.g., a local hard drive on an accessible computer, a connected portable storage device, a network server, or other networked storage—wherever the content “lives.”

In embodiments, the actual content is edited by or on the virtual application running on the virtual server. The virtual display (or “virtual screen”) of the content is then translated specifically for and sent to any of the co-using computer devices. Thus, the co-using devices (client or user computer devices, smartphones or tablets) do not actually interact with and edit the editable content itself. Rather, the co-using devices interact with the content while it resides in the virtual world via a virtual display transmitted from the virtual application. That is, users view a display of the content from the virtual application as that display changes to reflect input sent from the co-using computing devices. For example, a pdf may be opened by a virtual application and adapted or “mapped” to a virtual display. The virtual display may then be adapted or translated for each co-using computer device and transmitted to that device for display. The users of those computer devices may then input edits for the content through their specific devices, even though the mechanics and appearance of such edits may vary widely from device to device. Input from each device may be accepted or translated so that such input may be properly incorporated into the editable content and displayed on the virtual display. These inputs may be incorporated into the virtual display, which is then transmitted back to the co-browsing computer devices.

Potential users of co-editing methods include practitioners in fields, such as medicine, law, banking, real estate, insurance, and education, who need to interact with distant people, such as clients, customers, colleagues, or students who need or desire to create, edit, complete, submit or sign content.

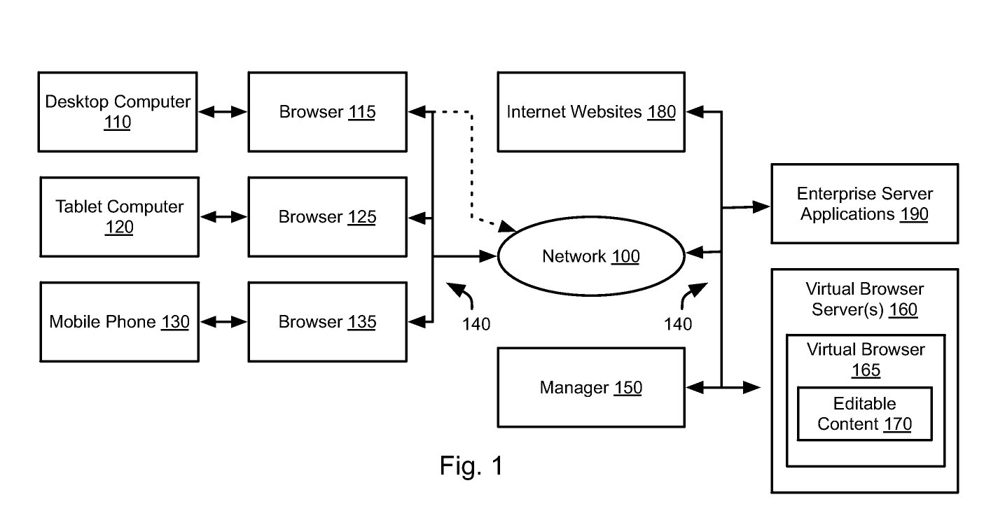

Now regarding the figures and the embodiments, FIG. 1 is a block diagram illustrating a number of embodiments for implementing the co-editing of content over a network. In an embodiment, FIG. 1 depicts network co-browsing, an embodiment of the co-use of a networked application that provides for the co-editing of content. In FIG. 1, user computers include a desktop computer 110, a tablet computer 120, and a mobile phone 130 (collectively “computer devices”). Computer devices 110, 120, and 130 are running browsers 115, 125, and 135, respectively. Computer devices 110, 120, and 130 connect to a network 100, employing browsers 115, 125, and 135 to interact with network 100. Internet websites 180, enterprise server applications 190, and virtual browser server(s) 160 are also connected to network 100. A virtual browser 165 is running on virtual browser server(s) 160. Editable content 170 is shown within virtual browser 165. A manager 150 is running on a device connected to network 100. Manager 150 may be running on any device connected to network 100, such as any of the devices 110, 120, 130 shown, and any device supporting any of websites 180, applications 190, or virtual browser 165. Network connections 140 generally connect devices 110, 120, and 130, and the servers supporting websites 180, applications 190, and virtual browser server(s) 160, to network 100.

Editable content 170 is content that may be edited by an application. In the embodiment of FIG. 1, editable content 170 is editable by the browser application used to instantiate virtual browser 165. Thus, editable content 170 may be the HTML source code for a webpage. But it should be understood that a browser application is but one type of application that may be used in embodiments that provide for the co-editing of content. Thus, in an embodiment, editable content may a text file opened within a virtual word-processing application running on a virtual word-processing application server. Similarly, editable content may be a pdf file opened within a virtual pdf application running on a virtual pdf application server. In this manner, editable content 170 may be any editable content, opened within a virtual version of any application capable of editing that content during a co-use session.

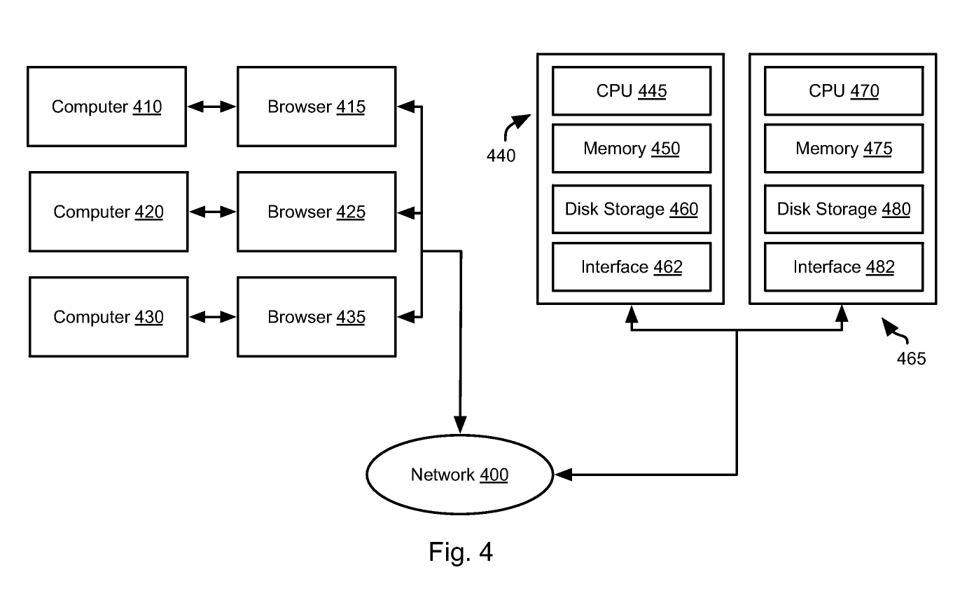

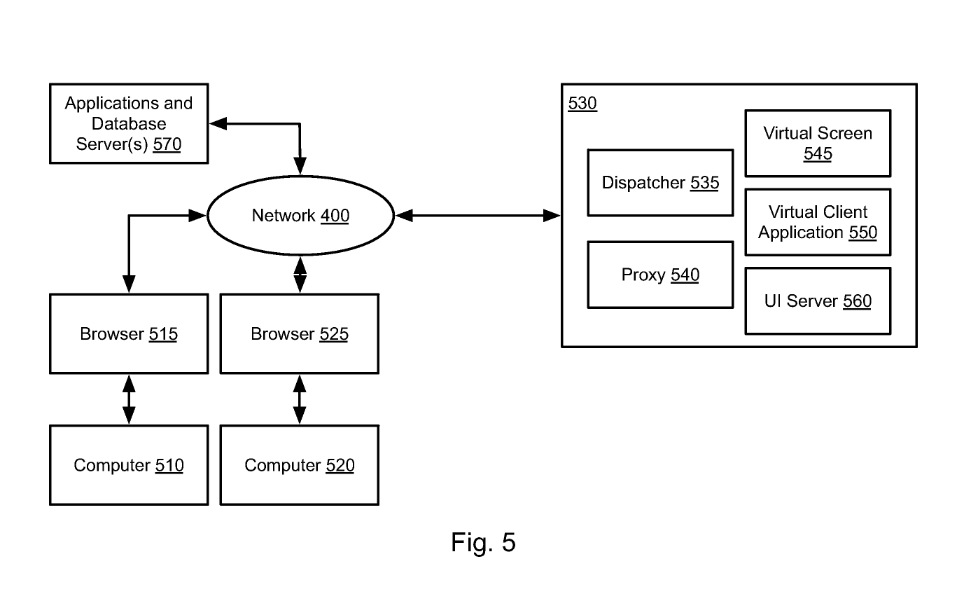

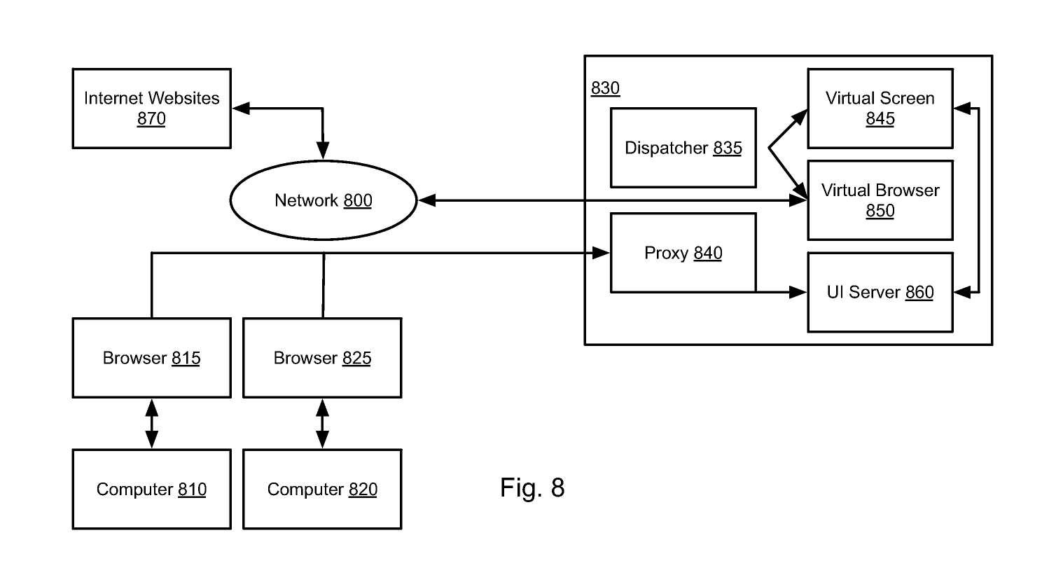

The implementation of a co-editing session is described in detail within in regard to FIGS. 4-14, with FIGS. 5-7 directed to virtual client applications generally, and FIGS. 8-13 again to virtual browsers. These figures and the related discussion should be understood to apply to client applications and browsers with an editing capability, including without limitation an ability to fill out, complete, and submit forms.

In an embodiment shown in FIG. 1, a co-browsing session among devices 110, 120, and 130 has been implemented using virtual browser 165. According to the embodiment, screen data from editable content 170 and virtual browser 165 is rendered on the display (not shown) of the different computing devices 110, 120, and 130 from the virtual display (not shown) of virtual browser 165. As such, the co-browsing session is not dependent on a format of any computing device of a user (e.g., desktop computer 110, tablet computer 120 or mobile phone 130). In this way, a mobile device 130 may host a web co-editing session and the screen data from the mobile device, although it originates from a small screen area, is translated to an environment appropriate for the larger desktop computer display.

In FIG. 1, according to an embodiment, a co-editing session has been instantiated as described in detail within. To initiate co-editing, a user, via desktop computer 110 and browser 115 may interact with virtual browser 165 and request that virtual browser 165 make editable content 170 available for editing. Virtual browser responds, opening or otherwise making editable content 170 available for simultaneous editing by any of the users of computer 110, computer 120, and phone 130. Thus, according to the embodiment, the request by one user during a co-browsing session to edit editable content 170 provides each co-browser with the ability to edit editable content 170 as well. In embodiments, the ability to edit content during a co-editing session may be withheld from certain participants in the session.

A user of the mobile phone 130 may resize the website response information to view it in a manner appropriate for a mobile device. Since both the desktop computer and a mobile computer see the data of the virtual display, the mobile phone may resize a portion of the website response information without affecting the size and view of the Website information displayed on the desktop computer. The co-editing sessions are also not affected by the means in which data is input to the computing devices as the input from each device 110, 120, and 130 is interpreted to edit content 170 appropriately. Similarly, the output from virtual browser 165 is translated according to the respective destination device. For example, a user may click on an image or link using a finger for a tablet computer or mobile device, and click on a link or image through a cursor control device (mouse, electrostatic pad) for a laptop or a desktop computer. The input means does not affect co-browsing on the other computing devices. Also, user computer devices may include plug-ins to execute processes and services particularly suitable for the native device. The plug-ins, which enhance the user experience based on the type of computing device, do not affect data seen on other co-browsing user devices. As such, co-editing is implemented among computers with disparate resources, including different screen sizes, input means and browser configurations.

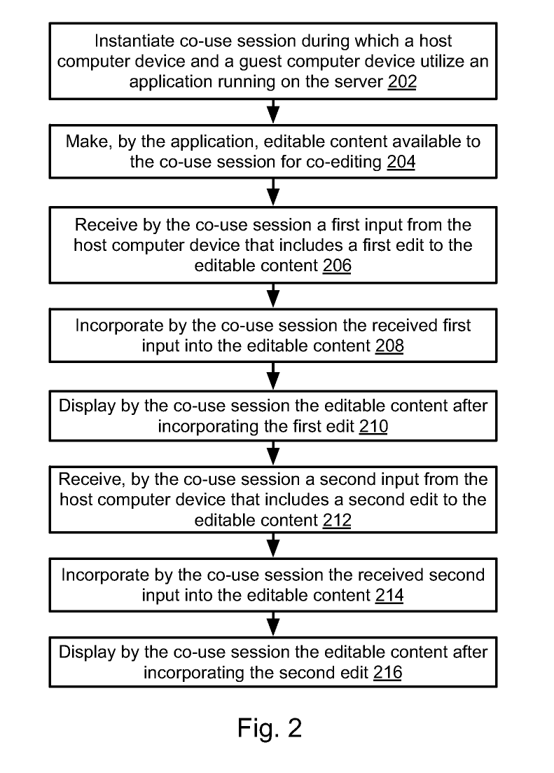

FIG. 2 is a flow diagram illustrating an embodiment of a method for implementing the co-editing of content over a network. The order of the steps in this or any other embodiment may be changed without departing from the method. Similarly, certain steps may not be necessary. In FIG. 2, at 202, a co-use session, embodiments of which are also described in detail regarding FIGS. 4-14, is instantiated on a server. The co-use session includes a host computer device and a guest computer device co-using an application running on the server. The application may also be called a “virtual application” because it is instantiated on a virtual server as discussed within. At 204, editable content is made available by the application to the co-use session for co-editing. At 206, a first input is received by the co-use session from the host computer device. The first input includes a first edit to the editable content. At 208, upon being received, the edit is incorporated into the editable content by the application running on the co-use session. At 210, the editable content is displayed by the co-use session as incorporating the first edit. At 212, a second input is received by the co-use session from the guest computer device. The second input includes a second edit to the editable content. At 214, upon being received, the second edit is incorporated into the editable content by the application running on the co-use session. At 216, the editable content is displayed by the co-use session as incorporating the second edit. Thus, steps 202-216 provide a method for the editing of content by multiple users during a co-browsing session. In the embodiment, input from each user is accepted, incorporated, and displayed to the co-browsing users as it is received. In embodiments, the number of co-browsing users may be greater than two. In embodiments, the number of co-editing users may be greater than two as well. In embodiments, though a first plurality of users may have access to the co-browsing session, and a second plurality of users may have access rights to co-edit the editable content, it may happen that only a subset of the second plurality actually choose to edit the content. Also, in any of the embodiments, the order of the user edits and the number of times a particular user edits the editable content may vary randomly.

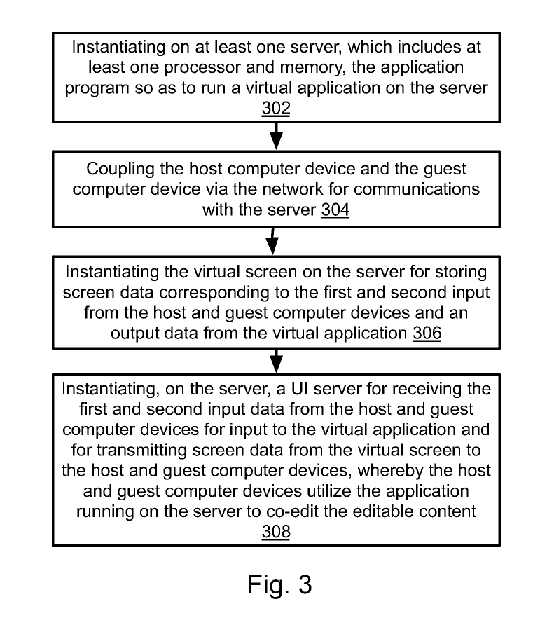

FIG. 3 is a flow diagram illustrating an embodiment of a method for implementing the co-editing of content over a network. In FIG. 3, at 302 an application program is instantiated on at least one server so as to run a “virtual application” on the server. At 304, as discussed with regard to FIG. 2, a host computer device and a guest computer device communicate with the server over a network. At 306, a virtual display is also instantiated on the server for storing screen data corresponding to input data from the host or guest computer device and an output data from the virtual application. At 308, a UI server is also instantiated on the server. The UI server receives the input data from the host and guest computer devices for subsequent input to the virtual application, and transmits the screen data from the virtual display to the host and guest computer devices. Under this configuration, the host and guest computer devices may effectively co-edit content using the application running on the server.

FIG. 4 is a block diagram illustrating a system to permit computers to remotely share computing resources and provide for a co-editing session. As shown in FIG. 4, computers 410, 420 and 430 access, through network 400, resources on computer (e.g., servers) 440 and 465. Computer servers 440 and 465 include computing resources, such as CPUs (445 and 470), memory (450 and 475) and disk storage (460 and 480). Servers 440 and 465 may be high-end servers with multiple processors, large amounts of memory, and large disk arrays. Conversely, computers 410, 420 and 430 may be computing devices of limited resources, such as mobile devices, tablet devices, or laptop computers. In general, computers 410, 420 and 430 access the servers (440 and 465) to utilize the CPU, memory and disk storage resources. For example, the computers 410, 420 and 430 may interface with servers 440 and 465 to remotely execute application programs that require CPU, memory and disk storage resources. For example, computers 410, 420 and 430 may utilize computer resources on servers 440 and 465 to execute enterprise applications and to browse Internet websites. Embodiments for co-use of applications and co-browsing of Internet Websites by multiple computers are described more fully below.

For the example of FIG. 4, computers 410, 420, and 430 may use computer resources of servers 440 and 465, thereby using only a minimum amount of local computer resources. To this end, computers 410, 420, and 430 operate Internet browsers (415, 425, and 435, respectively). The computers may run any type of Internet browser, such as commercially available browsers Google Chrome, Mozilla Firefox, Microsoft Explorer, etc. In order to provide computer resources, servers 440 and 465 include interface 462 and 482, respectively. Interface 462 and 482 permit communication (exchange of data) between computers (410, 420, and 430) and servers (440 and 465) by using only a browser. To this end, interface 462 and 482 formats all requests and responses between computers (410, 420, and 430) and servers (440 and 465) to the hypertext transfer protocol (HTTP). To accomplish this, interface (462 and 482) converts input/output from the applications running on the server to an HTTP format. Computers 410, 420, and 430 only consume a minimum amount of resources to operate their browsers while utilizing computing resources of servers 440 and 465 to execute software.

FIG. 5 is a block diagram illustrating one embodiment of a computer architecture to support remote operation of applications for use by one or more computing devices. For this example, software applications, such as enterprise applications, may run on one or more servers. As used herein, an application connotes any software application program that provides functionality. In some embodiments, the applications comprise enterprise applications. As used herein, an enterprise application may include any type of application software that typically runs in an enterprise software environment, including accounting software, customer resource management (CRM) software, enterprise resource planning (ERP) software, etc. For the example of FIG. 5, servers that operate applications, including database servers, are depicted as Applications and Database Server(s) 570. A virtual server 530, which may be implemented on one or more computers, operates to remote the application for computers 510 and 520. Applications and Database Servers 570, virtual server 530 and computers 510 and 520 are all accessible through network 500 (e.g., wide area network).

For this example, computers 510 and 520 desire to share use of an application program (e.g., enterprise application) running on Applications and Database Server(s) 570. As such, computers 510 and 520 “co-use” the enterprise application (i.e., both computers interact with an applications program in a collaborative environment). In some embodiments, the application may run in a client-server environment. For the example of FIG. 5, the server portion of the application program runs on Applications and Database Servers 570, while the client portion runs on virtual server 530 for the benefit of computers 510 and 520.

For this embodiment, the virtual server 530, which may operate on one or more computers, comprises several subcomponents to facilitate the remote operation of the application for the benefit of computers 510 and 520. Specifically, for this embodiment, virtual server 530 includes dispatcher 535. As is explained more fully below, dispatcher 535 initiates a session for multiple users to run enterprise software by instantiating batch processes associated with the session. For this embodiment, the batch processes include virtual screen 545, virtual client application 550 and user interface (UI) server 560. In general, virtual screen 545 stores screen data of the application for viewing on computers 510 and 520. The virtual client application 550 runs the client portion of the application and supplies screen data to virtual screen 545. UI server 560 monitors input data from computers 510 and 520 and updates input to virtual screen 545 and virtual client application 550, as appropriate. UI server 560 may implement processes such as virtual network computing (VNC) or remote desktop protocol (RDP). Proxy 540 operates to connect computers 510 and 520 to the batch processes (i.e., virtual screen 545, virtual client application 550 and UI server 560) instantiated by dispatcher 535. In embodiments, proxy 540 may comprise translation proxy, such as translation proxies 240 (FIG. 2) and 440 (FIG. 4), which connect to their respective computers using WebSocket connections, to obtain the benefits described of such an arrangement.

In operation, virtual client application 550 transmits input data to the server portion of the application (running on Applications and Database Server(s) 570). In turn, the application, running on Applications and Database Server(s) 570, outputs data, including screen data, to virtual client application 550 in a manner typical for operation in a client-server environment. Virtual server 530 transmits screen data to, and receives input data from, computers 510 and 520 via an Internet protocol.

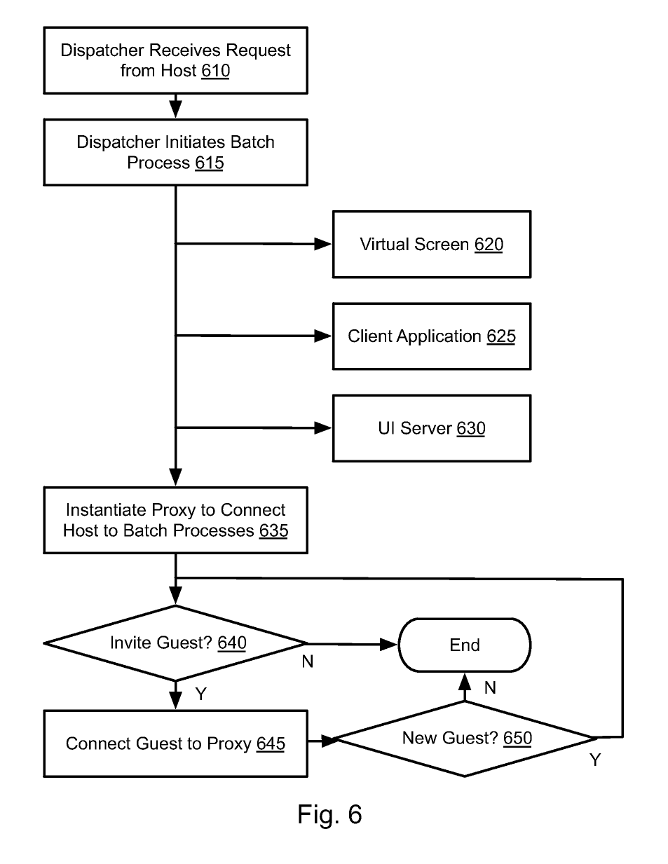

FIG. 6 is a flow diagram illustrating one embodiment to initiate a session among multiple users to co-use a software application. In some embodiments, the system designates a host to initiate the co-use session with the application software. Then, the host invites one or more guests to “co-use” the resources of the software application. The process begins as the dispatcher receives a request from a host to initiate a session with the application (block 610, FIG. 6). In response to the request, the dispatcher initiates the batch processes (block 615, FIG. 6) to instantiate the virtual screen (620), client application (625) and UI server (630). Then, a proxy, which connects the host to the batch processes, is instantiated. The host may then invite one or more guests, and the guests are connected to the proxy (which connects the guests to the batch process services) (blocks 640 and 645, FIG. 6). If the host desires to add a new guest, then the process is repeated and subsequently the new user is connected to the proxy so as to gain access to the batch process services (blocks 650, 640 and 645, FIG. 6). If all guests have been connected to the batch process service, then the initialization is complete.

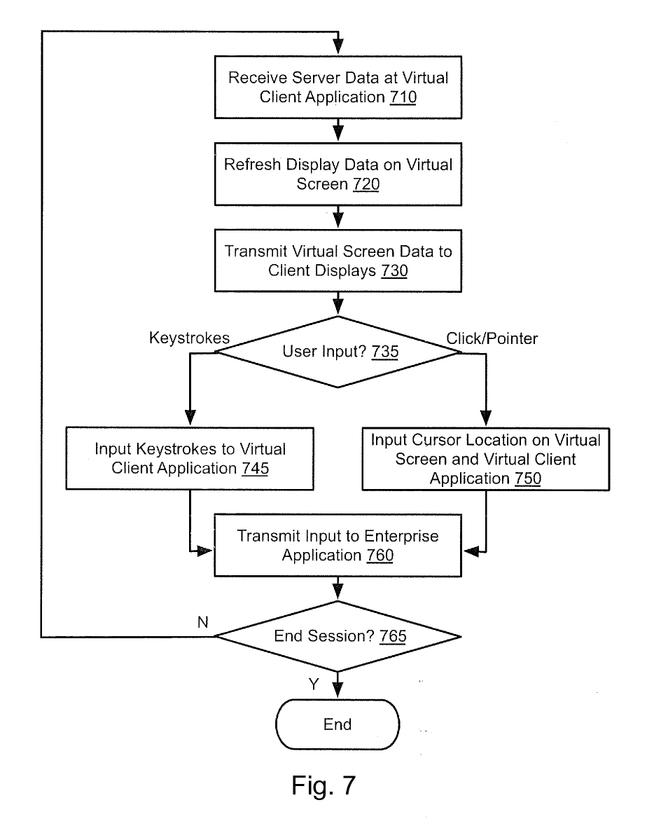

FIG. 7 is a flow diagram illustrating one embodiment for a process for multiple users to co-use an application program. As described above, the application may run on one or more remote servers, and the virtual client application forms a client-server environment with the application and database server(s). For this embodiment, the process begins when the virtual client application, running on the virtual server, receives data from the application (block 710, FIG. 7). For example, the application may comprise a login screen to facilitate a user, such as the host, to log-on to the application. In response to receiving the data at the virtual application, the display data is refreshed on the virtual screen (block 720, FIG. 7). For example, if the application transmits a logon screen, then a rendition of the logon screen is rendered on the virtual screen on the virtual server. The updated virtual screen data is then transmitted to the user computers for rendering on the various client displays. For example, if one user computer consists of a mobile device, then the application logon screen is rendered on the display of the mobile device. Similarly, if the user computer device consists of a desktop computer, with a high-resolution output display, the logon screen for the application software is rendered on the high-resolution output display. Then, the process waits for input from the user computers (block 735, FIG. 7). If the system server receives, from one or more user computers, keystrokes, then the keystrokes are input to the virtual client application (block 745, FIG. 7). If the user computer inputs a click, along with cursor position information, then the input cursor location and click are updated on the virtual screen and input to the virtual client application (blocks 735 and 750, FIG. 7). In one embodiment, the UI server monitors keystroke, click and cursor position from the user computers to perform these functions. The input data (keystroke, click and cursor position) from the user computers is transmitted to the application from the virtual client application (block 760, FIG. 7). This process, which includes receiving data from the application, transmitting screen data to the user computers, receiving input data from the user computers, and subsequently inputting data to the application, is repeated until users desire to end the session with the application.

The application co-use techniques disclosed herein support use cases for training and service of applications software. For example, a host may co-use an application to train a guest in learning to use the application. Under this use case scenario, a host may conduct transactions with the application through the virtual server. Then, a guest may interact with the application software without requiring the host to relinquish control to the guest. In contrast, in a screen sharing application, the host computer transfers control to the guest computer in order to permit the guest computer to conduct transactions with the application.

The application co-use techniques disclosed herein support the filling out of forms. For example, a host, such as an insurance representative, may begin a virtual browsing session and co-use an application with a guest, such as a client. The application may allow a user to fill out a form. By co-using that application during a co-browsing session, both host/representative and guest/client may edit any forms opened within the application. In this manner, the host/representative may both instruct the guest/client on the proper filling out of forms and verify that the guest/client has actually and properly filled out the forms. Furthermore, once such forms are properly filled out, the host/representative may instruct the guest/client on the proper way to submit the forms and verify that the forms were properly submitted. Or the host/representative my submit the forms themselves. Thus, by opening a co-browsing session and co-using an application, the host/representative may direct the guest/user throughout the entire form-filling process, including: instructing the guest/client how to fill out the forms; walking the guest/client through the forms as the guest/client fills them out; witnessing that the forms were filled out by the guest/client; verifying that the forms were filled out by the guest/client properly; and verifying that the guest/client submitted the forms properly (or submitting the forms themselves). Further examples of such host/guest pairs may generally include any pair (or more) who both may participate in the completion of a document or other content. Such pairs may include, for example: attorney/client, doctor (MD)/patient, teacher/student, employer/applicant, mortgage broker/mortgage applicant, real estate broker/(buyer or seller), parent/child, author/co-author, photographer/subject, sound engineer/musician, etc.

The application co-use techniques disclosed herein support the creation or modification of content in general. The examples given above are directed to the co-use of an application to fill out forms. It should be understood to filling out of forms is an example of editing or co-editing a form, that is, modifying the content of the form. Similarly, it should be understood that “editing” and “co-editing” include without limitation the modification of content. For example, in addition to filling out forms, “editing” and “co-editing” may refer to completing applications, drafting documents, creating code, modifying images, modifying sound files, modifying video, and modifying presentations, etc. Furthermore, though the example given above is directed to the co-use of an application to fill out forms, it should be understood that the filling out of forms is itself an example of creating content. Thus, it should be understood that “editing” and “co-editing” include without limitation the creation of content. For example, in addition to filling out forms, “editing” and “co-editing” may refer to creating applications, documents, code, images, sound files, video, and presentations, etc.

As such, the application co-use techniques disclosed herein support co-using applications between users without requiring transfer of control or host screens. The application co-use techniques disclosed herein support use cases that effectively require switching control between users such that both co-users input data to the application. As such, application co-use techniques disclosed herein provide an environment for true collaboration because users are not required to execute functions in order to transfer the ability for each co-user to input data into the application.

FIG. 8 is a block diagram illustrating an embodiment of a system configured to initiate the co-use of a virtual application. To illustrate the co-use of an application, this example describes a co-browsing session. Dispatcher 835 receives a request from browser 815 or 825 to begin Web browsing sessions and, in turn, initiates, as a batch process, virtual screen 845, virtual browser 850, UI server 860, and proxy 840 processes. Dispatcher 835 may also be called a “manager.” After a session has been started, computers 810 and 820 access the batch processes through proxy 840. In conducting a co-browsing session, users, from computers 810 and 820, operating through their respective browsers (815 and 825), access a virtual browser 850 on virtual server 830 via network 800 (virtual server 830 should be understood to be connected to computers 810 and 820 through network 800, though the connections are not shown in FIG. 8). The virtual browser 850 operates to access Internet websites 870 through network 800. The virtual screen 845 stores screen data for replication to computers 810 and 820. UI server 860 monitors incoming data from browsers (815 and 825) of computers (810 and 820) and inputs the incoming data to virtual screen 845 and UI server 860. UI server 860 may run communication protocols, such as virtual network computing (VNC), or remote desktop protocol (RDP).

In operation, users, through computers 810 and 820, access Websites (Internet websites 870). Users enter website information into their respective browsers (815 and 825). This website information is input to the virtual browser 850 by way of proxy 840, UI server 860, and virtual screen 845. Virtual browser 850, operating like browser 815 and 825, accesses the Internet websites through a standard HTTP TCP/IP protocol. Virtual browser 850 transmits the website information, input by the users, to the Internet websites 870, and retrieves website response data returned by the Website. The response data is transferred to the virtual screen 845, and subsequently transmitted to computers 810 and 812, through browsers, for display at computers 810 and 812.

As the sessions are co-browsing, any user (user of computer 810 or user computer 820) may input information (keystrokes, clicks and cursor position), and the input information is both displayed on the virtual screen and interpreted for a web request to the Internet websites 870. In some embodiments, the co-browsing session designates a host and one or more guests. For this embodiment, the host may initiate a co-browsing session with one or more guests.

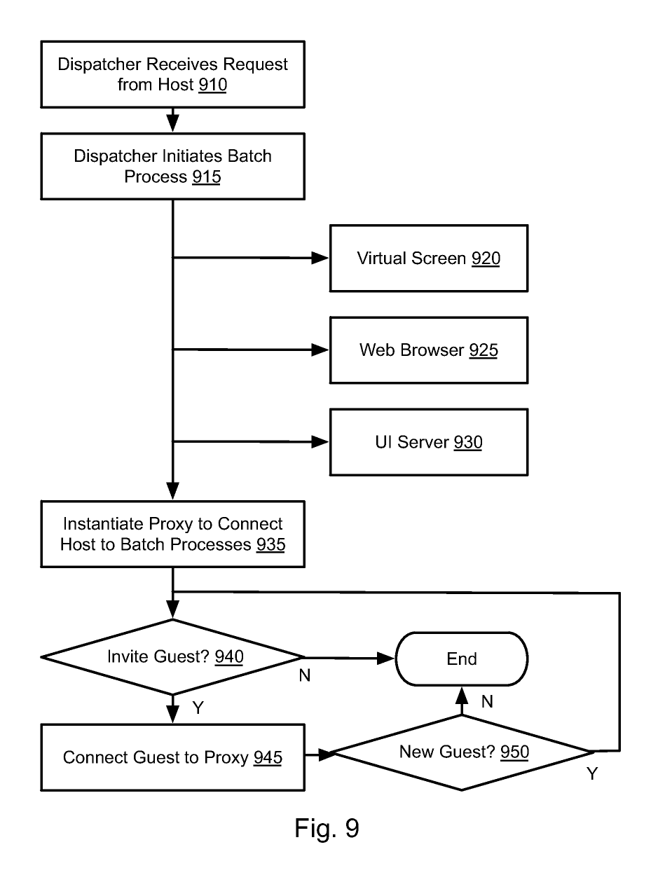

FIG. 9 is a flow diagram illustrating one embodiment for initiating a co-browsing session. The dispatcher receives a request from a host to initiate a web browsing session (block 910, FIG. 9). In response to the request, the dispatcher initiates batch processes (block 915, FIG. 9) that include virtual screen (block 920), virtual web browser (block 925) and UI server (block 930). Then, a proxy is instantiated to connect the host computer to the initiated batch processes (block 935). The host user is now connected for a web browsing session. To add one or more guests, the host, in some predetermined protocol, may invite a guest (block 940, FIG. 9). To add a guest, the guest connects to the batch processes via a proxy. Similarly, additional guests for the co-browsing session may be entered (block 950, 940 and 945, FIG. 9).

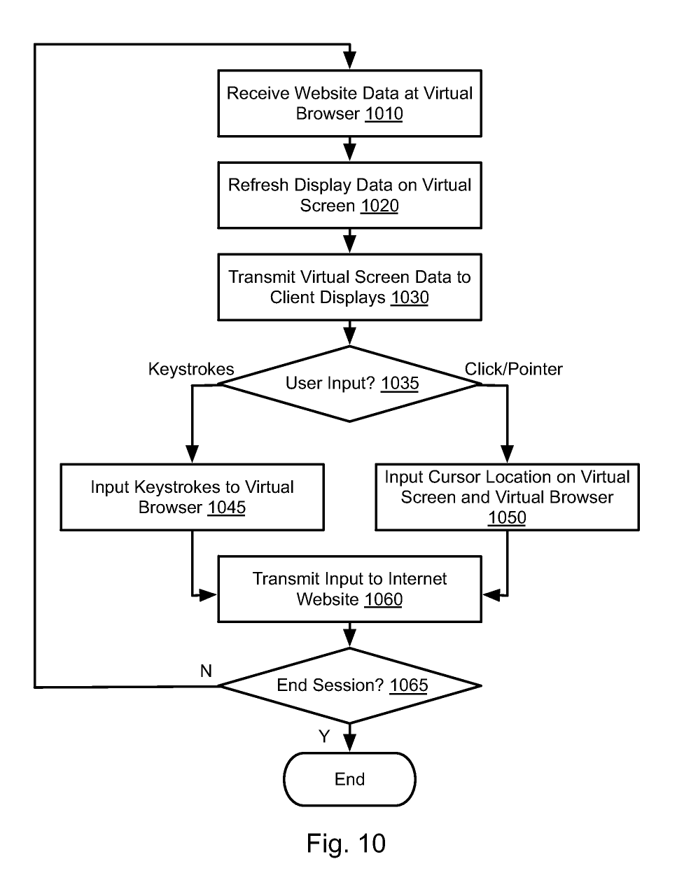

FIG. 10 is a flow diagram illustrating one embodiment for a co-browsing process. Initially, a user sends web information to access a Website of interest. The web information is received at the virtual browser (block 1010, FIG. 10). The display screen on the virtual screen is refreshed (block 1020, FIG. 10). The virtual screen data is transmitted, over the network, for display on the user computers. The requests, including the web information, output from the user computers, are monitored to detect a user operation (i.e., input keystroke, clicks, and cursor position). If the user inputs keystrokes, then the keystrokes are input to the virtual browser, as appropriate (block 1045, FIG. 10). If the user inputs clicks and cursor position, the input cursor location is input to the virtual screen and the virtual browser (blocks 1035 and 1050, FIG. 10). In response to the input data, the virtual browser transmits the web information to Internet websites (block 1060, FIG. 10). The steps for the user to request web information from the user device and subsequently retrieve response information from the virtual server and Internet websites are repeated for each request and response cycle (blocks 1010, 1020, 1030, 1035, 1045, 1050, 1060).

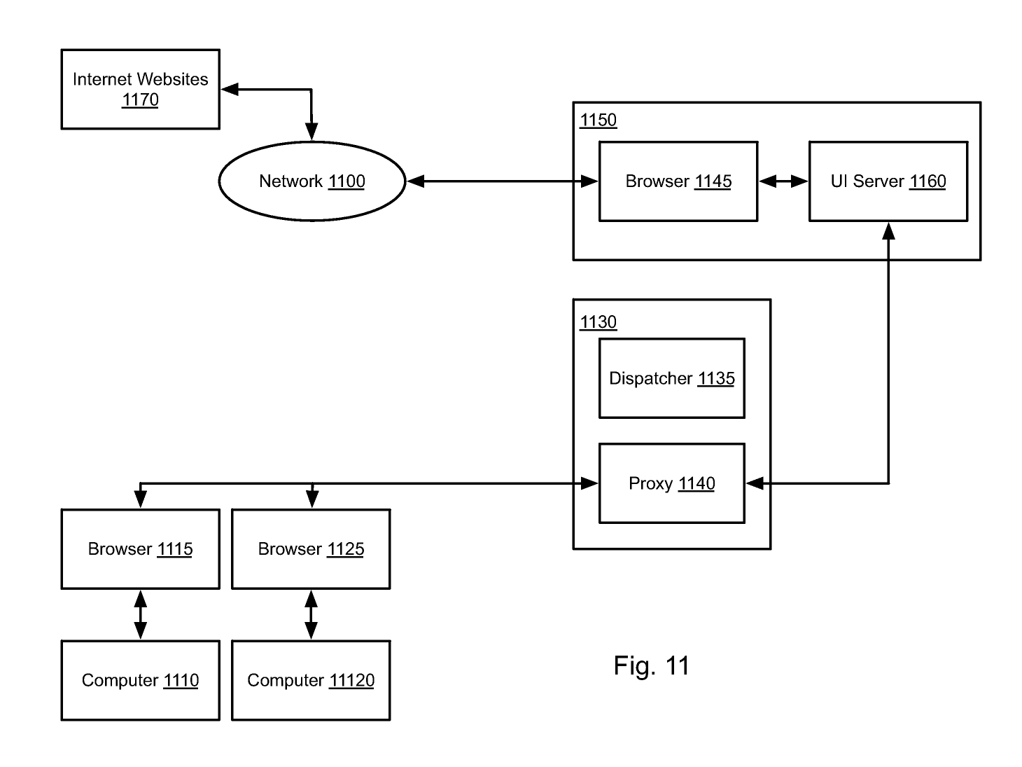

FIG. 11 is a block diagram illustrating a system configured for the co-use of an application. To illustrate the co-use of an application, this example describes a co-browsing session. Requests to begin Web co-browsing sessions may be initiated by any users as discussed previously, but in this example a request is initiated by the user of computer 1150. Dispatcher 1135 receives requests to begin Web co-browsing sessions and, in turn, initiates, as a batch process, UI server 1160, and proxy 1140 processes. Dispatcher 1135 may also be called a “manager.” UI server 1160 is instantiated on computer 1150 and proxy 1140 is instantiated on virtual server 1130. In conducting a co-browsing session, users, from computers 1110 and 1120, operating through their respective browsers (1115 and 1125), access a browser 1145 on computer 1150 via virtual server 1130 and network 1100 (virtual server 1130 should be understood to be connected to computers 1110 and 1120 through network 1100, though the connections are not shown in FIG. 11). Browser 1145 operates to access Internet websites 1170 through network 1100. UI server 1160 on computer 1150 and monitors incoming data from browsers (1115 and 1125) of computers (1110 and 1120) and inputs the incoming data to browser 1145. UI server 1160 monitors screen data from browser 1145 and user input from computer 1150 and transmits the screen data and user input to browsers 1115 and 1125. UI server 1160 may employ, for example, processes for communications, such as virtual network computing (VNC), or remote desktop protocol (RDP). Dispatcher 1135 receives requests to begin Web co-browsing sessions and, in turn, initiates, as a batch process, UI server 1160, and proxy 1140 processes. Dispatcher 1135 may also be called a “manager.” In some embodiments, proxy 1140 is instantiated within the same private network as UI server 1160. In some embodiments, the UI server 1160 may communicate directly with computers 1110 and 1120.

In operation, users, through computers 1110 and 1120, access Websites (Internet websites 1170). Users enter website information into their respective browsers (1115 and 1125). This website information is input to browser 1145 by way of proxy 1140 and UI server 1160. Browser 1145 accesses Internet websites 1170 through a standard HTTP TCP/IP protocol. Browser 1145 transmits the website information, input by the users, to Internet websites 1170, and retrieves website response data returned by the Website. The response data is transmitted to computers 1110 and 1112, through UI server 1160, proxy 1140, and browsers 1115 and 1125, for display at computers 1110 and 1112.

As the sessions are co-browsing, any user (user of computer 1110 or user computer 1120 or user of computer 1150) may input information (keystrokes, clicks and cursor position), and the input information is both displayed on computers 1150, 1110, and 1120, and interpreted for a web request to the Internet websites 1170. In some embodiments, the co-browsing session designates computer 1150 as a host and computers 1110 and 1120 as guests. In this example, the host computer 1150 has initiated the co-browsing session with guest computers 1110 and 1120.

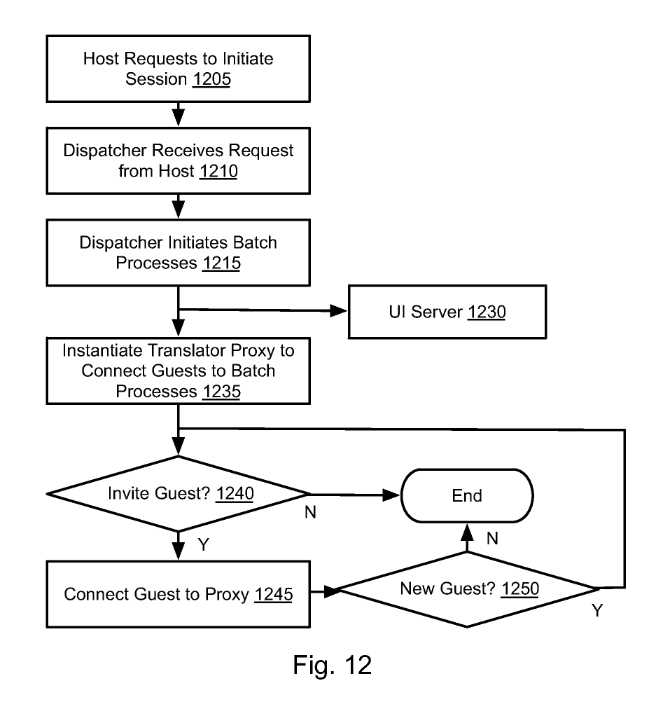

FIG. 12 is a flow diagram illustrating one embodiment for initiating a co-browsing session. A host initiates the co-browsing session (block 1205). The dispatcher 1135 (FIG. 11) receives a request from the host to initiate a web browsing session (block 1210). In response to the request, the dispatcher initiates batch processes (block 1215) that include a UI server (block 1230). Then, a proxy is instantiated to connect the host and subsequent invited guest computers to the initiated batch processes (block 1235). To add one or more guests, the host, in some predetermined protocol, may invite a guest (block 1240). To add a guest, the guest connects to the batch processes via a proxy, translator or otherwise (block 1245). Similarly, additional guests for the co-browsing session may be entered (block 1250, 1240 and 1245).

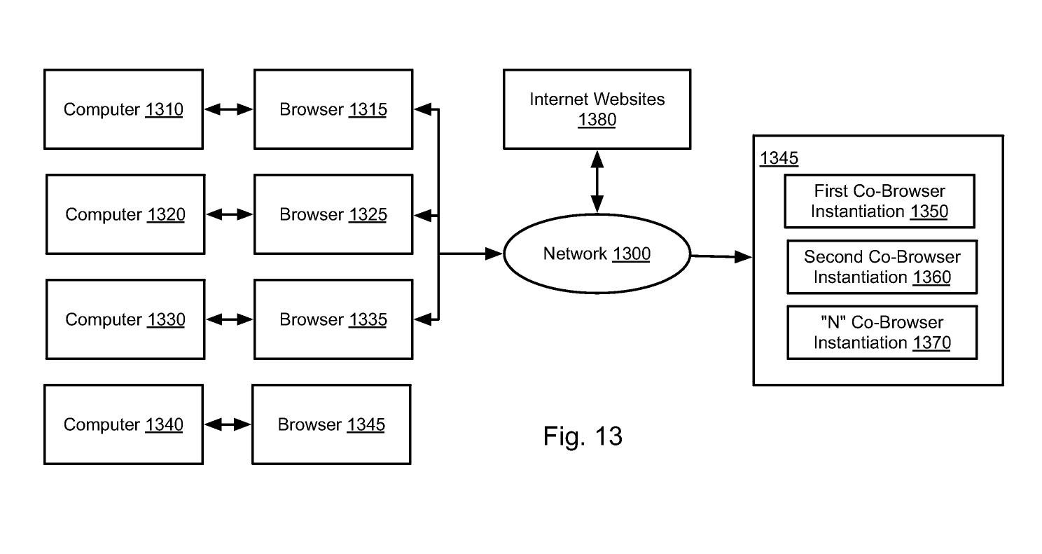

FIG. 13 is a block diagram illustrating co-browsing with multiple co-browser instantiations at the virtual server. As shown in FIG. 13, virtual server 1390 supports multiple co-browsing sessions simultaneously. In this way, any user on a computing device (computer 1310, 1320, 1330 and 1340) may enter into one or more co-browsing sessions with another user through a browser (e.g., browser 1315, 1325, 1335, or 1345). For example, computer 1310, through browser 1315, may enter into a first co-browsing session with user of computer 1320. In the first co-browsing session, data is generated (i.e., cookie data collected from websites visited). Co-browsing data for the first co-browsing session may be stored in the first co-browser instantiation 1350. A second co-browsing session, supported by a second co-browser instantiation 1360, may include a browsing session with computers 1330 and 1340. Similarly, any combination of any user computers may enter into a co-browsing session to create any number of “N” co-browsing sessions. For example, computer 1310, although in a co-browsing session with computer 1320, may enter into a couple browsing session with computer 1330 or 1340.

Typically, in a co-browsing session, cookies are shared among the computers co-browsing. In the co-browsing techniques disclosed herein, session data (cookies) are not shared. All session data remains at the virtual server (on the virtual browser). As such, the co-browsing techniques disclosed herein provide a secure co-browsing environment for the user computers.

The co-browsing techniques disclosed herein support saving and securing session data for different sessions. In one use case, a host may wish to start several different sessions with different users. For example, a host of a virtual shopping experience may start a co-browsing session with multiple users. For the example configuration shown in FIG. 13, the host user may use computer 1310 and browser 1315. The guest users, in this example, may use computers 1320, 1330 and 1340. The host computer 1310 may co-browse with computer users 1320, 1330 and 1340, to create session data in the first co-browser instantiation (1350). Then, the host user (computer 1310) may desire to create a second co-browser instantiation 1360 to conduct a one-on-one session between host computer 1310 and guest computer 1320. During co-browsing in this second co-browsing session, all session data is stored within the second co-browser instantiation 1360. In this matter, any number of sessions may be created and the co-browsing data, collected during the session, may be secured and stored. It this way, a co-browsing session may be continued in the future by using session data from a prior co-browsing session.

The co-browsing architecture disclosed herein supports the ability to co-browse among all Internet websites. Using these embodiments, websites do not require special Java enabled scripts for execution in a user computer browser. One application for co-browsing is the creation of a virtual party with multiple browsers. In one use case, a host may provide a shopping experience for one or more guests. The host may want to navigate to different websites and present different products and services to the guests. Using the co-browsing techniques described herein, the host may shop at any retailer website without restriction to only shopping at co-browser enabled websites. Similarly, a co-browsing session may be used to plan travel among one or more friends arranging a trip. Again, the co-browsing users may navigate to any website without restrictions as to whether the website is browser enabled. Since the co-browsing session to organize a trip would potentially include many different types of websites (e.g., websites for transportation, hotels, entertainment, etc.), the co-browsing techniques described herein support use cases where the co-browsing session includes many different types of websites.

### Computer & Network System

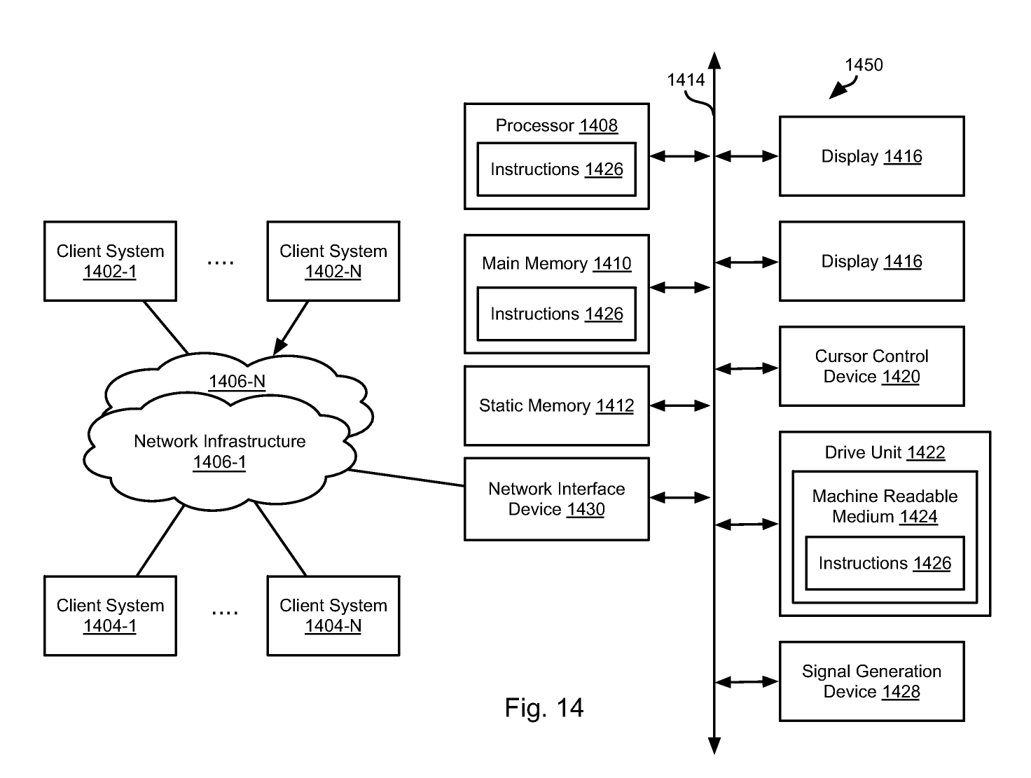

FIG. 14 is a diagrammatic representation of a network 1400, including nodes for client computer systems 1402₁ through 1402_{N}, nodes for server computer systems 1404₁ through 1404_{N}, nodes for network infrastructure 1406₁ through 1406_{N}, any of which nodes may comprise a machine 1450 within which a set of instructions for causing the machine to perform any one of the techniques discussed above may be executed. The embodiment shown is purely exemplary, and might be implemented in the context of one or more of the figures herein.

Any node of the network 1400 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1450 includes a processor 1408 (e.g. a processor core, a microprocessor, a computing device, etc.), a main memory 1410 and a static memory 1412, which communicate with each other via a bus 1414. The machine 1450 may further include a display unit 1416 that may comprise a touch-screen, or a liquid crystal display (LCD), or a light emitting diode (LED) display, or a cathode ray tube (CRT). As shown, the computer system 1450 also includes a human input/output (I/O) device 1418 (e.g. a keyboard, an alphanumeric keypad, etc.), a pointing device 1420 (e.g. a mouse, a touch screen, etc.), a drive unit 1422 (e.g. a disk drive unit, a CD/DVD drive, a tangible computer readable removable media drive, an SSD storage device, etc.), a signal generation device 1428 (e.g. a speaker, an audio output, etc.), and a network interface device 1430 (e.g. an Ethernet interface, a wired network interface, a wireless network interface, a propagated signal interface, etc.).

The drive unit 1422 includes a machine-readable medium 1424 on which is stored a set of instructions (i.e. software, firmware, middleware, etc.) 1426 embodying any one, or all, of the methodologies described above. The set of instructions 1426 is also shown to reside, completely or at least partially, within the main memory 1410 and/or within the processor 1408. The set of instructions 1426 may further be transmitted or received via the network interface device 1430 over the network bus 1414.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

Although the present invention has been described in terms of specific exemplary embodiments, it will be appreciated that various modifications and alterations might be made by those skilled in the art without departing from the spirit and scope of the invention. In particular, functionality ascribed herein to a server, desktop computer, laptop computer, or other computing device may also be performed by a mobile computing device such as a mobile phone, tablet computer, wearable computer, or other type of computing device having computing resources sufficient to perform the recited functionality.

What is claimed is:

1. A method comprising:
associating, by a host system, a first computer system and a second computer system with a co-editing session with respect to a document;
rendering, by the host system, the document in a virtual screen using a virtual client;
receiving, by the host system, edits to the document from the first and second computer systems;
editing, by the host system, the document according to the edits;
translating, by the host system, images of the virtual screen to obtain first images suitable for presentation on the first computer system;
translating, by the host system, images of the virtual screen to obtain second images suitable for presentation on the second computer system, the second images being translated differently than the first images;
transmitting, by the host system, the first images of the virtual screen to the first computer system in response to the edits to the document; and
transmitting, by the host system, the second images of the virtual screen to the second computer system in response to the edits to the document.

2. The method of claim 1, wherein the document is a webpage and the virtual client is a virtual web browser.

3. The method of claim 2, wherein the webpage is an online form.

4. The method of claim 3, wherein the edits comprise inputs to blanks of the online form.

5. The method of claim 4, further comprising:
receiving, by the host system from the first computer system, instructions for filling of the online form;
transmitting, by the host system to the second computer system, the instructions for filling the online form; and
receiving, by the host system, the inputs to the blanks of the online form from the second computer system.

6. The method of claim 1, wherein the first images are formatted for a different screen size then the second images.

7. The method of claim 1, wherein the first images are formatted for display on a mobile computing device and the second images are formatted for display on a high-resolution desktop computer.

8. The method of claim 1, further comprising:
instantiating a user interface server on the host system;
receiving, by the user interface server, the edits; and
inputting, by the user interface server, the edits to the virtual client.

9. The method of claim 1, further comprising:
establishing a network connection between the virtual client and a proxy;
establishing network connections between the proxy and the first and second computer systems.

10. The method of claim 1, wherein the edits include at least one of keystrokes, cursor movements, and clicks.

11. A system comprising one or more processing devices and one or more memory devices operably coupled to the one or more processing devices, the one or more memory devices storing executable code effective to cause the one or more processors to:
associate a first computer system and a second computer system with a co-editing session with respect to a document;
render the document in a virtual screen using a virtual client;
receive edits to the document from the first and second computer systems;
edit the document according to the edits;
translate images of the virtual screen to obtain first images suitable for presentation on the first computer system;
translate images of the virtual screen to obtain second images suitable for presentation on the second computer system, the second images being translated differently than the first images;
transmit the first images of the virtual screen to the first computer system in response to the edits to the document; and
transmit the second images of the virtual screen to the second computer system in response to the edits to the document.

12. The system of claim 11, wherein the document is a webpage and the virtual client is a virtual web browser.

13. The system of claim 12, wherein the webpage is an online form.

14. The system of claim 13, wherein the edits comprise inputs to blanks of the online form.

15. The system of claim 14, wherein the executable code is further effective to cause the one or more processors to:
receive, from the first computer system, instructions for filling of the online form;
transmit, to the second computer system, the instructions for filling the online form; and
receive the inputs to the blanks of the online form from the second computer system.

16. The system of claim 11, wherein the first images are formatted for a different screen size then the second images.

17. The system of claim 11, wherein the first images are formatted for display on a mobile computing device and the second images are formatted for display on a high-resolution desktop computer.

18. The system of claim 11, wherein the executable code is further effective to cause the one or more processors to:
instantiate a user interface server;
receive, by the user interface server, the edits; and
input, by the user interface server, the edits to the virtual client.

19. The system of claim 11, wherein the executable code is further effective to cause the one or more processors to:
establish a network connection between the virtual client and a proxy;
establish network connections between the proxy and the first and second computer systems.

20. The system of claim 11, wherein the edits include at least one of keystrokes, cursor movements, and clicks.
